(19) United States
(12) Patent Application Publication
(10) Pub. No.: US 2008/0192038 A1
(43) Pub. Date: Aug. 14, 2008

(54) Display panel

(75) Inventors: Po-Yuan Liu, Hsin-Chu (TW); Ming-Sheng Lai, Hsin-Chu (TW)

Correspondence Address: RABIN & Berdo, PC, 1101 14TH STREET, NW, SUITE 500, WASHINGTON, DC, 20005, US

(73) Assignee: AU OPTRONICS CORP., Hsin-Chu (TW)

(21) Appl. No.: 11/889,880

(22) Filed: Aug. 17, 2007

(30) Foreign Application Priority Data
Feb. 13, 2007 (TW) 96105355

(51) Int. Cl. G09G 5/00

(52) U.S. Cl. 345/206

(57) ABSTRACT

A display panel including a substrate, several data driving circuits, at least one first scan driving circuit and at least one second scan driving circuit is provided. The substrate has a display region and at least one non-display region adjacent to the display region. The non-display region has at least one first area, at least one second area, and at least one third area, wherein the first area connects the second and the third area. The data driving circuits are disposed on the first area and are electrically connected in serial. The first scan driving circuit is disposed on the second area. The second scan driving circuit is disposed on the third area.

This application claims the benefit of Taiwan application No. 96105355, filed Feb. 13, 2007, the contents of which are herein incorporated by reference in its entirety.

### BACKGROUND OF THE INVENTION

1. Field of the Invention

The present invention relates in general to a display panel, and more particularly, to a display panel disposing one or several scan driving circuits at the two sides of the display region and incorporating serially connected data driving circuits.

2. Description of the Related Art

With the advance in science and technology, display panel has become indispensable to modern people in their daily life. Display panel is now widely used in various electronic devices such as TV, monitor, personal digital assistant (PDA), and mobile phone, and adds more funs and convenience to people's life.

Referring to FIG. 1, a conventional display panel is shown. As indicated in FIG. 1, the display panel 10 includes a substrate 11, several source drivers 12, several gate drivers 13, several flexible circuit boards 18 and a printed circuit board 17. The substrate 11 has a display region 15 and a non-display region 16 adjacent to the display region 15. That is, the non-display region 16 is around the display region 15. The non-display region 16 has a first area 16a and a second area 16b, wherein the first area 16a is adjacent to the second area 16b. The source drivers 12 are disposed on the first area 16a and are mutually independent and electrically isolated. The gate drivers 13 are disposed on the second area 16b and are electrically connected in serial. The flexible circuit boards 18 are mutually independent and are disposed between the first area 16a of the substrate 11 and the printed circuit board 17. Each flexible circuit board 18 correspondingly electrically connects the source driver 12 with the printed circuit board 17. Besides, the flexible circuit board 18 disposed at the leftmost side of FIG. 1 is used for transmitting the first signals A and the second signals B to the gate drivers 13 and the source drivers 12, respectively, wherein the first signals A and the second signals B are the scan driving circuit signals and the data and control signals, respectively. Besides, each of the remaining flexible circuit boards 18 is used for transmitting the second signal B to a corresponding source driver 12.

However, as each flexible circuit board 18 is used for transmitting a second signal B to a corresponding source driver 12, the number of flexible circuit boards 18 will be the same as the number of source drivers 12, such as ten for example. Thus, the size and layers of printed circuit board 17 as well as the size and required quantity of flexible circuit boards 18 will be increased accordingly, hence increasing more manufacturing cost. Besides, the conventional gate driver 13 is bonded onto the substrate 11 via a gate driving IC according to the chip on glass (COG) technology. Thus, an additional manufacturing process of bonding the gate driving IC onto the substrate 11 is necessary, and the manufacturing cost is increased further.

### SUMMARY OF THE INVENTION

The present invention is directed to a display panel. With the design of disposing one or several scan driving circuits at the two sides of the display region and incorporating serially connected data driving circuits, the size and layers of circuit boards as well as the size and required quantity of flexible circuit boards are reduced, hence reducing the manufacturing cost.

According to the present invention, a display panel including a substrate, several data driving circuits, at least one first scan driving circuit and at least one second scan driving circuit is provided. The substrate has a display region and at least one non-display region adjacent to the display region. The non-display region has at least one first area, at least one second area and at least one third area, wherein the first area is connected with the second area and the third area. The data driving circuits are disposed on the first area and are electrically connected in serial. The first scan driving circuit is disposed on the second area. The second scan driving circuit is disposed on the third area.

The present invention will become apparent from the following detailed description of the preferred but non-limiting embodiments. The following description is made with reference to the accompanying drawings.

### BRIEF DESCRIPTION OF THE DRAWINGS

FIG. 1 shows a conventional display panel (Related Art);

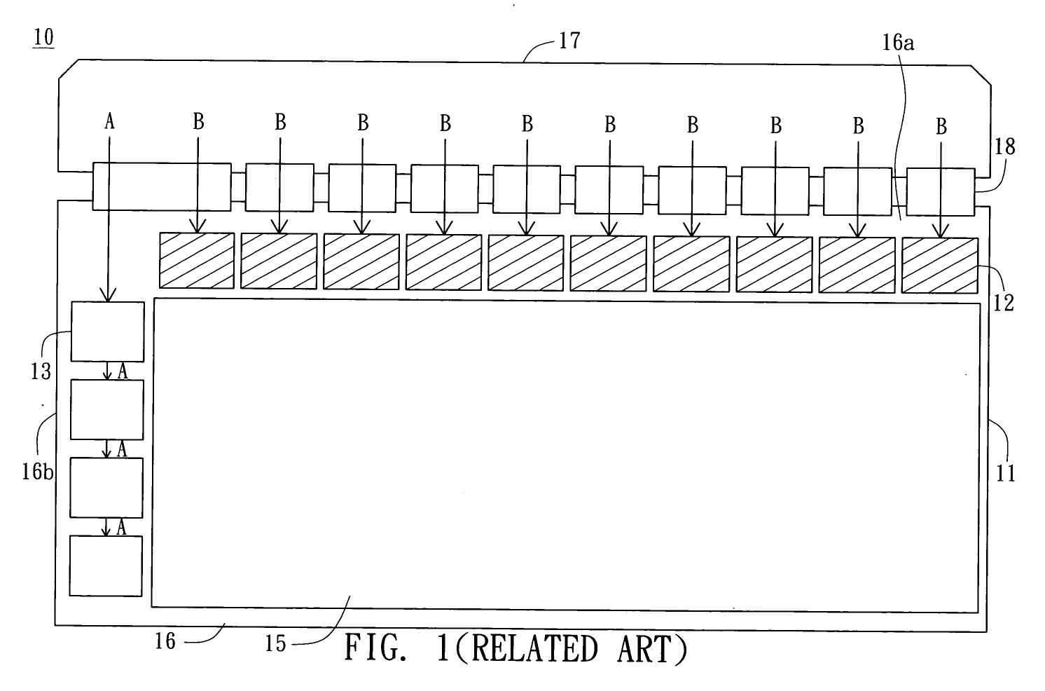

FIG. 2 shows a display panel according to a first embodiment of the present invention;

FIG. 3 shows a display panel according to a second embodiment of the present invention;

FIG. 4 shows a display panel according to a third embodiment of the present invention; and

FIG. 5 shows a display panel according to a fourth embodiment of the present invention.

### DETAILED DESCRIPTION OF THE INVENTION

### First Embodiment

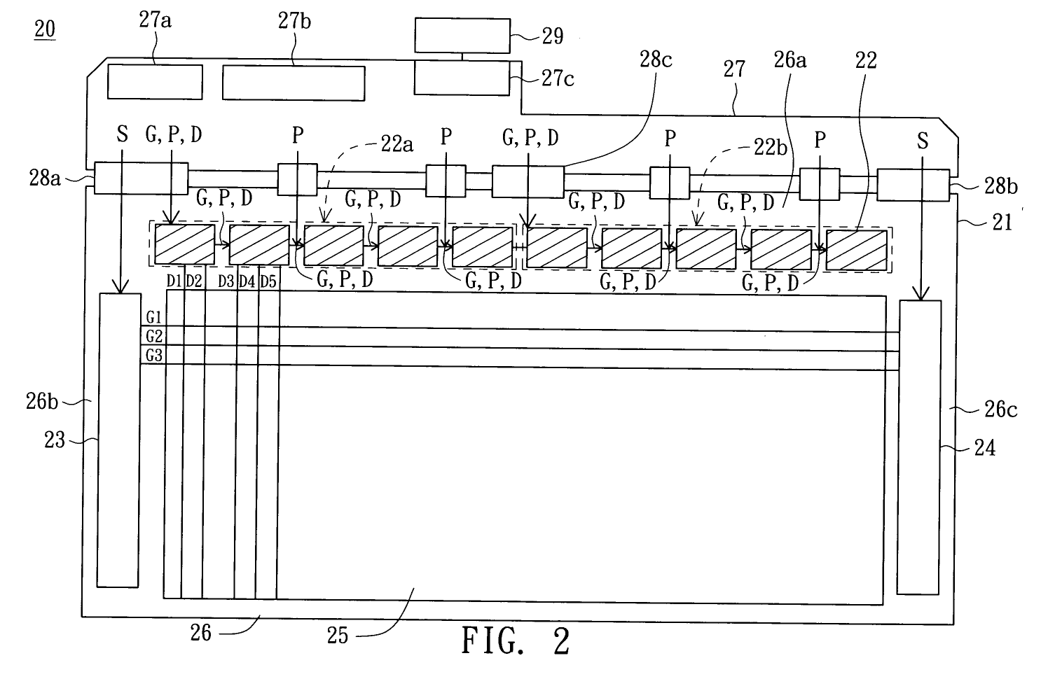

Referring to FIG. 2, a display panel according to a first embodiment of the present invention is shown. As indicated in FIG. 2, the display panel 20 includes a substrate 21, several data driving circuits 22, at least one first scan driving circuit 23 and at least one second scan driving circuit 24. The substrate 21 has a display region 25 and at least one non-display region 26 adjacent to the display region 25. That is, the non-display region 26 substantially arounds the display region 25. In other words, the non-display region 26 is located at the outside of the display region 25. The non-display region 26 has at least one first area 26a, at least one second area 26b, and at least one third area 26c, wherein the first area 26a connects the second area 26b and the third area 26c. Besides, the second area 26b is opposite to the third area 26c. The data driving circuits 22 are disposed on the first area 26a and are electrically connected in serial, and are called serially connected data driving circuits. The data driving circuits 22 include such as a source driver, a source driving IC, a system on substrate (SOS), a chip on substrate (COS), a source driver on array (SOA), or other types. In the present invention, the data driving circuits 22 are exemplified by source drivers but are not limited thereto. Moreover, examples of the material of the substrate 21 include transparent material (such as glass, quartz or other materials), non-transparent material (such as ceramic, semiconductor, or other materials), flexible material (such as plastics, polyester, polymethyl acrylamide or other materials), or a combination thereof. In the embodiments of the present invention, the substrate 21 is made from a transparent material exemplified by glass but is not limited thereto. Besides, the number of data driving circuits 22 is exemplified by 10, but is not limited thereto. For example, the number of data driving circuits 22 can be 2, 3, 4, 5, 6, 7, 8, 9, 11, . . . or any number that fit the size of the substrate 21 and actual needs in design. The data driving circuits 22 are mutually interspaced. The first scan driving circuit 23 is disposed on the second area 26b. The second scan driving circuit 24 is disposed on the third area 26c. According to the present embodiment of the invention, separate scan driving circuits are disposed at the two sides outside of the display region 25, largely transcending the conventional design where the gate drivers are disposed at only one side outside the display region. Moreover, at least one of the first scan driving circuit 23 and the second scan driving circuit 24 includes a shift register circuit (SRC). That is, one of the first scan driving circuit 23 and the second scan driving circuit 24 has a shift register circuit, or both the first scan driving circuit 23 and the second scan driving circuit 24 have a shift register circuit. Preferably, by simultaneously forming the shift register circuit and the pixel array on the substrate 21, the manufacturing cost of the scan driving circuit is saved. It is noted that at least one of the first scan driving circuit 23 and the second scan driving circuit 24 can be electrically connected in serial and is called serially connected scan driving circuit. At least one of the first scan driving circuit 23 and the second scan driving circuit 24 includes, such as a gate driver, a gate driving IC, a system on substrate (SOS), a chip on substrate (COS), a gate driver on array (GOA), or other types. In the present embodiment of the invention, at least one of the first scan driving circuit 23 and the second scan driving circuit 24 is the gate driver, but is not limited thereto.

In the present embodiment of the invention, the display panel 20 further includes at least one circuit board 27, at least one first flexible circuit board 28a, at least one second flexible circuit board 28b, and several third flexible circuit boards 28c. Examples of the circuit board 27 include flexible circuit board, printed circuit board, or a combination thereof. In the present embodiment of the invention, the circuit board 27 is exemplified by a printed circuit board, but is not limited thereto. The first flexible circuit board 28a is disposed between the substrate 21 and the circuit board 27, such as connected between the first area 26a and the circuit board 27, and is electrically connected with the circuit board 27, the first scan driving circuit 23 and a portion of the data driving circuits 22. Besides, the second flexible circuit board 28b is disposed between the substrate 21 and the circuit board 27, such as connected between the third area 26c and the circuit board 27, and is electrically connected with the circuit board 27 and the second scan driving circuit 24. Besides, the third flexible circuit boards 28c are disposed between the substrate 21 and the circuit board 27, such as connected between the first area 26a and the circuit board 27, and is electrically connected with the circuit board 27 and the data driving circuits 22. The third flexible circuit boards 28c are mutually interspaced and each is disposed between the first flexible circuit board 28a and the second flexible circuit board 28b. The present embodiment of the invention is exemplified by one first flexible circuit board 28a, one second flexible circuit board 28b and five third flexible circuit boards 28c, but is not limited thereto. For example, the number of first flexible circuit board 28a is at least one (such as 1, 2, 3, 4, 5, 6, . . . or any other number), the number of second flexible circuit board 28b is at least one (such as 1, 2, 3, 4, 5, 6, . . . or any other number) and the third flexible circuit board 28c is at least one (such as 1, 2, 3, 4, 5, 6, 7, 8, . . . or any other number). The first flexible circuit board 28a, the second flexible circuit board 28b and the third flexible circuit board 28c can have any number that fits the size of the substrate 21 and actual needs in design.

The data driving circuits 22 are divided into at least one first group 22a and at least one second group 22b as indicated in FIG. 2. For example, in the present embodiment of the invention, the first group 22a includes the five data driving circuits 22 at the left-hand side, that is, the five data driving circuits 22 counted from left to right; the second group 22b includes the five data driving circuits 22 at the right-hand side, that is, the five data driving circuits 22 counted from right to left. However, the ways of grouping the data driving circuits 22 are not limited thereto. The data driving circuits 22 can be divided into several groups according to the size of the substrate 21 and actual needs. Basically, each group includes at least one data driving circuit 22, and the number of data driving circuits 22 in each group does not/does need to be the same. Moreover, despite the flexible circuit boards are divided into several groups in the drawing of the present embodiment of the invention, the present invention is not limited thereto. For example, in the present embodiment of the invention the data driving circuits 22 do not need to be grouped. In other words, all of the data driving circuits 22 can be considered as one group. The disposition and grouping of the first flexible circuit boards 28a and the second flexible circuit boards 28b remain the same or different, and the third flexible circuit boards 28c having to provide a signal (such as power signal P, gamma signal G, data and control signal D, and so on) are located at predetermined position according to the size of the substrate 21 and actual needs in design.

Besides, the first flexible circuit board 28a is electrically connected with the circuit board 27, the first scan driving circuit 23, and one data driving circuit 22 of the first group 22a. For example, the first flexible circuit board 28a is electrically connected with the data driving circuits 22 at the leftmost side of FIG. 2 and the first flexible circuit board 28a is adapted to transmit a signal from the circuit board 27 to the first scan driving circuit 23 and the data driving circuits 22 at the leftmost side of FIG. 2. The second flexible circuit board 28b is electrically connected with the circuit board 27, the second scan driving circuit 24, and one data driving circuit 22 of the second group 22b. For example, the second flexible circuit board 28b is electrically connected with the data driving circuit 22 at the rightmost side of FIG. 2 and the second flexible circuit board 28b is adapted to transmit a signal from the circuit board 27 to the second scan driving circuit 24 and the data driving circuit 22 at the rightmost side of FIG. 2. Moreover, the third flexible circuit boards 28c are electrically connected with the second group 22b and the first group 22a, respectively. For example, the third flexible circuit boards 28a are electrically connected with the eight data driving circuits 22 in the middle of FIG. 2 and the third flexible circuit boards 28c are adapted to transmit signals from the circuit board 27 to the eight data driving circuits 22 in the middle of FIG. 2.

The first flexible circuit board 28a and the third flexible circuit board 28c are respectively adapted to transmit signals to the data driving circuits 22 of the first group 22a and the second group 22b. That is, a signal transmitted to the first group 22a by the first flexible circuit board 28a is substantially equal to a signal transmitted to the second group 22b by one of the third flexible circuit boards 28c. For example, the first flexible circuit board 28a transmits at least one power signal P, at least one gamma signal G, and at least one data and control signal D to a data driving circuit 22 at the leftmost side of FIG. 2, wherein the data driving circuit 22 belongs to the first group 22a. The data driving circuits 22 of the first group 22a, from left to right, sequentially transmit the power signal P, the gamma signal G, and the data and control signal D to the next data driving circuit 22 from one of the data driving circuits 22 until all the signals are transmitted to the fifth data driving circuit 22 of FIG. 2 counted from left to right. Besides, the third flexible circuit board 28c corresponds to the boundary between the first group 22a and the second group 22b can also transmit at least one power signal P, at least one gamma signal G, and at least one data and control signal D to a fifth data driving circuit 22 of FIG. 2 counted from right to left, wherein the data driving circuit 22 belongs to the second group 22b. The data driving circuits 22 of the second group 22b, from left to right, sequentially transmit the power signal P, the gamma signal G, and the data and control signal D to the next data driving circuit 22 from one of the data driving circuits 22 until all the signals are transmitted to the data driving circuit 22 at the rightmost side of FIG. 2. Thus, the signals transmitted on the data driving circuits 22 of the first group 22a and the second group 22b do not decay easily, such that the intensity of signal at the first data driving circuit 22 at the leftmost side of FIG. 2 of the first group 22a is substantially equal to or substantially larger than that of the last data driving circuit 22 of the second group 22b at the rightmost side of FIG. 2. That is, the intensity of signal at the data driving circuits 22 of the first group 22a does not change much comparing with that of the second group 22b.

With respect to the transmission of signal from the third flexible circuit board 28c to data driving circuits 22 of the first group 22a and the second group 22b, a signal transmitted to the first group 22a by a portion of the third flexible circuit boards 28c is substantially equal to another signal transmitted to the second group 22b by another portion of the third flexible circuit boards 28c. For example, the preceding two of the third flexible circuit boards 28c counted from left to right of FIG. 2 respectively transmit the power signals P to the data driving circuits 22 of the first group 22a; the preceding two of the third flexible circuit boards 28c counted from right to left of FIG. 2 respectively transmit the power signals P to the data driving circuits 22 of the second group 22b.

With respect to the transmission of signal from the first flexible circuit board 28a and the second flexible circuit board 28b to the first scan driving circuit 23 and the second scan driving circuit 24, a signal transmitted to the second scan driving circuit 24 by the second flexible circuit board 28b is substantially equal to at least one signal transmitted to the first scan driving circuit 23 by the first flexible circuit board 28a. For example, the second flexible circuit board 28b transmits a scan driving circuit signal S to the second scan driving circuit 24, and the first flexible circuit board 28a transmits a scan driving circuit signal S to the first scan driving circuit 23.

Moreover, the circuit board 27 includes at least one power circuit 27a, at least one IC element 27b, at least one connected port 27c, or other elements. The power circuit 27a is adapted to receive an external power and accordingly outputs a power signal P for the display panel 20. The IC element 27b is adapted to receive the external signal and accordingly outputs at least one of the scan driving circuit signal S, the gamma signal G, and the data control signal D. Examples of the IC element 27b include timing controller, memory, application specific integrated circuit (ASIC), and so on, for example. The connected port 27c is adapted to electrically connect the circuit board 27 with a system 29. Examples of the system 29 include computer, display card, signal processor, look-up table, other devices, or a combination thereof. The system 29 is disposed on a photoelectronic display device incorporating the display panel 20. Examples of the display panel 20 include monitor, TV, notebook computer, touch panel, display screen of portable electronic product (such as mobile phone, digital camera (DC), digital video (DV), digital audio device, personal digital assistant (PDA), black berry, digital photo-frame, or other similar products), handheld game device (such as game boy, play station portable (PSP), Nintendo DS Lite, or other similar game devices), vehicle audio/video device, outdoor or indoor display panel, and outdoor or indoor indicating panel. It is noted that a portion of signals of the flexible circuit board are emitted by the IC element 27b on the circuit board 27, and the other portion of signals enter the display panel 20 via the connecting port 27c.

Any one who is skilled in the technology will comprehend that the present embodiment of the invention is not limited to the above exemplification and disclosure. For example, the display region 25 includes several data lines and scan lines, which are exemplified by the scan lines G1, G2 and G3 and the data lines D1, D2, D3, D4 and D5. The data lines D1, D2, D3, D4 and D5 are corresponding to and electrically connected with the data driving circuits 22. The scan lines G1, G2 and G3 are substantially interlaced with the data lines D1, D2, D3, D4 and D5, and the scan lines G1, G2 and G3 are electrically connected with at least one of the first scan driving circuit 23 and the second scan driving circuit 24. In the present embodiment of the invention, each one end of the scan lines G1, G2 and G3 is electrically connected with the first scan driving circuit 23, and each another one end of the scan lines G1, G2 and G3 is electrically connected with the second scan driving circuit 24; or, a portion of the scan lines are electrically connected with the first scan driving circuit 23 and another portion of the scan lines are electrically connected with the second scan driving circuit 24, for example, the odd-numbered scan lines are electrically connected with the first scan driving circuit 23 and the even-numbered scan lines are electrically connected with the second scan driving circuit 24, the odd-numbered scan lines are electrically connected with the second scan driving circuit 24 and the even-numbered scan lines electrically connected with the first scan driving circuit 23, a plurality of scan line groups respectively are electrically connected with the first scan driving circuit 23 and the second scan driving circuit 24, or a combination of connected ways thereof. Moreover, the display panel 20 is a liquid crystal display (LCD) panel or an organic electro-luminescence device (OELD) display panel. Examples of the liquid crystal display panel include transmissive panel, transflective panel, reflective panel, dual-display panel, vertical alignment (VA) panel, in-plane switching (IPS) panel, multi-domain vertical alignment (MVA) panel, twisted nematic (TN) panel, super twisted nematic (STN) panel, patterned vertical alignment (PVA) panel, super patterned vertical alignment (S-PVA) panel, advanced super view (ASV) panel, fringe-field switching (FFS) panel, continuous pinwheel alignment (CPA) panel, Axially Symmetric aligned Microcell (ASM) panel, optical compensation bend (OCB) panel, super in-plane switching (S-IPS) panel, advanced super in-plane switching (AS-IPS) panel, ultra fringe-field switching panel (UFFS), polymer stabilization alignment (PSA), dual-view panel, triple-view panel, other panel, or a combination thereof. The organic electro-luminescence device (OELD) is made of small molecule, polyester, or a combination thereof.

It is noted that if the data driving circuit of the embodiment of the present invention is formed according to such as chip on glass (COG) technology, then the source ends of the source drivings IC are electrically connected in serial via the wires on array (WOA), such as conductive wire, on the substrate 21 for transmitting a signal, such as power signal, gamma signal, clock signal, and data and control signal, for the display panel 20 to display a frame. Compared with the source driver of conventional display panel, the design of serially connected data driving circuits of the embodiment of the present invention reduces the size and layers of the circuit board as well as the size and required quantity of the flexible circuit board, hence reducing manufacturing cost significantly. With regard to the design of the scan driving circuit, the embodiment of the present invention preferably adopts the gate driver on array (GOA) on the substrate 21, and integrates the shift register circuit of the gate driving IC on the substrate 21 during the array process of the display panel 20. As a result, the manufacturing process of bonding the gate driving IC onto the substrate 21 is saved, largely reducing the manufacturing cost. As for the signal such as start pulse (ST) signal, clock (CK) and opposite clock (XCK) signal and low level voltage (VSS) signal controlled by the driving circuit and required by the shift register circuit of the first scan driving circuit 23 and the second scan driving circuit 24, after an external signal is received by the circuit board 27, the external signal is inputted to the wires on array (WOA) via the first flexible circuit board 28a and the second flexible circuit board 28b, then the external signal is transmitted to every unit of the shift register circuit for enabling the shift register circuit to function and provide the signal to each scan line such as the scan lines G1, G2 and G3.

### Second Embodiment

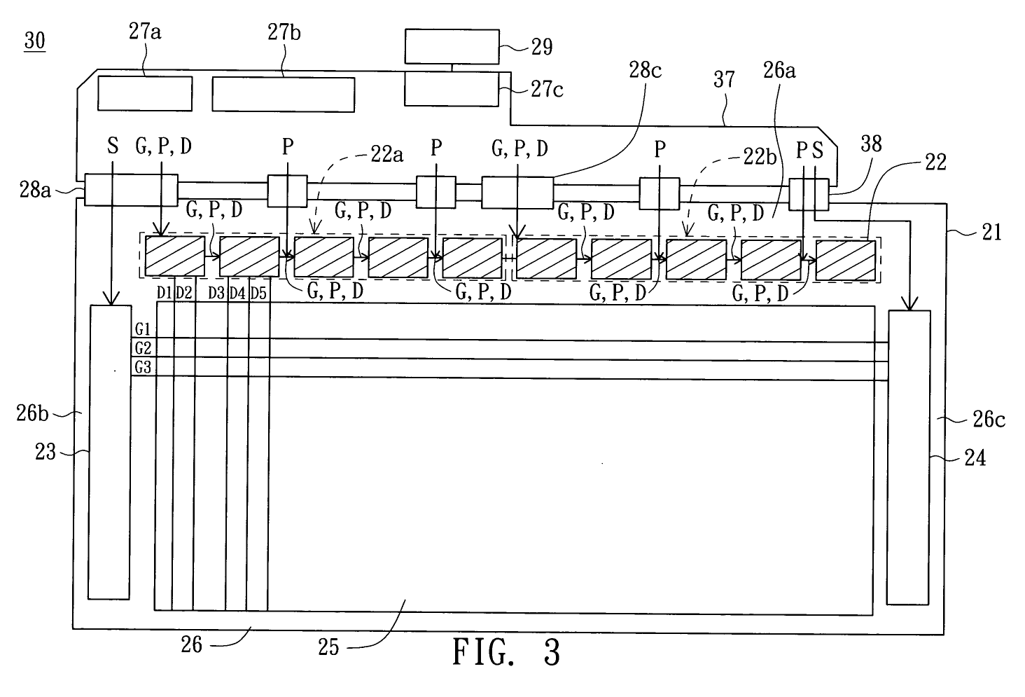

Referring to FIG. 3, a display panel according to a second embodiment of the present invention is shown. The display panel 30 of the present embodiment of the invention differs with the display panel 20 of the first embodiment in the second flexible circuit board 38 and the circuit board 37. Besides, the circuit board 37 of the present embodiment of the invention further differs with the circuit board 27 of the first embodiment in that the circuit board 37 is indented deeper into the first area 26a of the substrate 21 than the circuit board 27 of the first embodiment. In other words, the width of the circuit board 37 is substantially smaller than the sum of the width of display area 25 in the horizontal direction, the width of the second area 26b in the horizontal direction and the width of the third area 26c in the horizontal direction. Moreover, compared with the display panel 20 of the first embodiment, the display panel 30 of the present embodiment of the invention omits one third flexible circuit board 28c. As for other similar elements, the same numeric designations are used and are not repeated here. Related description is illustrated in FIG. 2 and, is not repeated here.

As indicated in FIG. 3, the second flexible circuit board 38 is electrically connected with a portion of the data driving circuits 22 and the second scan driving circuit 24. The second flexible circuit board 38 is electrically connected with at least one data driving circuit 22 of the second group 22b as indicated in the data driving circuits 22 at the rightmost side of FIG. 3. The second flexible circuit board 38 transmits a scan driving circuit signal S to the second scan driving circuit 24. Moreover, the second flexible circuit board 38 transmits a power signal P to at least one data driving circuit 22 of the second group 22b. Examples of the circuit board 37 include flexible circuit board, printed circuit board, or a combination thereof. In the present embodiment of the invention, the circuit board 37 is exemplified by a printed circuit board.

In the present embodiment of the invention, after the scan driving circuit signal S is transmitted by the second flexible circuit board 38, the scan driving circuit signal S, via the conductive wire, such as wires on array (WOA), on the substrate, passes through a segment of signal transmission path at the corner connecting the first area 26a and the third area 26c, then the scan driving circuit signal S is transmitted to the second scan driving circuit 24. Thus, compared with the display panel 20 of the first embodiment, the display panel 30 of the present embodiment of the invention saves one third flexible circuit board 28c, and reduces the area of the circuit board, hence reducing the manufacturing cost.

### Third Embodiment

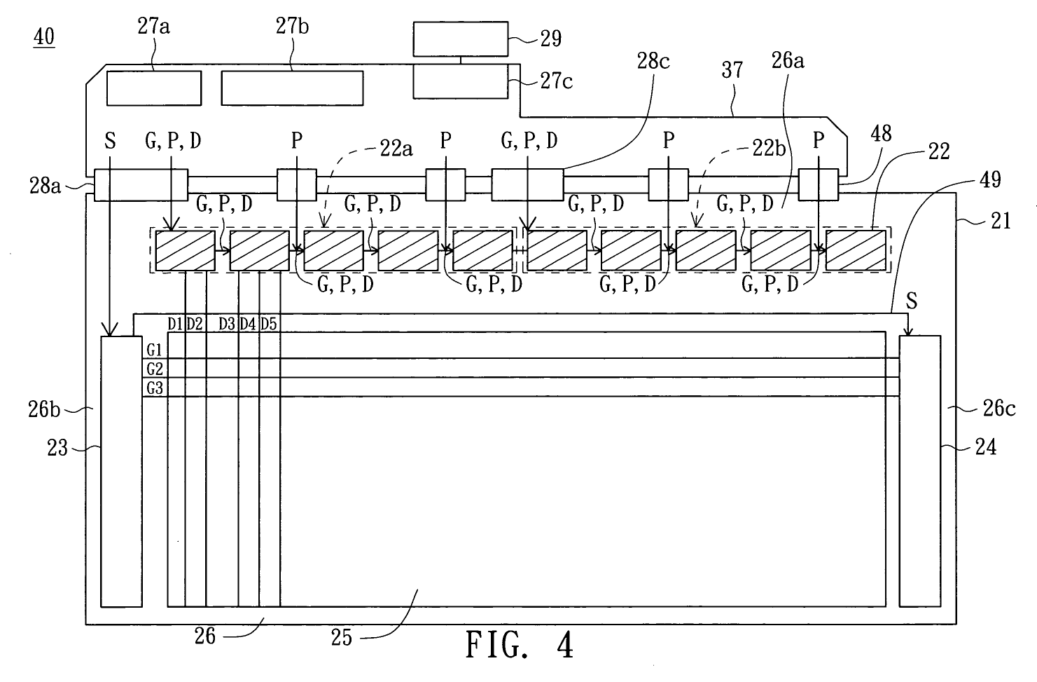

Referring to FIG. 4, a display panel according to a third embodiment of the present invention is shown. The display panel 40 of the present embodiment of the invention differs with the display panel 30 of the second embodiment in the second flexible circuit board 48 and the design of adding at least one conductive wire 49 on the substrate 21. As for other similar elements, the same numeric designations are used and are not repeated here.

As indicated in FIG. 4, the conductive wire 49 is disposed on the first area 26a and is electrically connected with the first scan driving circuit 23 and the second scan driving circuit 24. When the first flexible circuit board 28a transmits a scan driving circuit signal S to the first scan driving circuit 23, via the conductive wire 49 which is electrically connected with the first scan driving circuit 23 and the second scan driving circuit 24, the scan driving circuit signal S is transmitted to the second scan driving circuit 24 at the same time. Besides, the second flexible circuit board 48 is electrically connected with a portion of the data driving circuits 22, but is not electrically connected with the second scan driving circuit 24. The second flexible circuit board 48 is electrically connected with at least one data driving circuit 22 of the second group 22b as indicated in the data driving circuit 22 at the rightmost side of FIG. 4. Moreover, the second flexible circuit board 48 transmits a power signal P to at least one data driving circuit 22 of the second group 22b. It is noted that the circuit board of the present embodiment of the invention does not have to be indented deeper into the first area of the substrate. That is, the right side of the circuit board of the present embodiment of the invention can be aligned with the right side of the substrate. Alternatively, the width of the circuit board 37 can be substantially smaller than the sum of the width of display area 25 in the horizontal direction, the width of the second area 26b in the horizontal direction and the width of the third area 26c in the horizontal direction. Besides, the conductive wire 49 of the present embodiment of the invention is electrically connected with the first scan driving circuit 23 and the second scan driving circuit 24 but is not limited thereto. For example, the conductive wire 49 can be connected with the path of transmission between the first flexible circuit board 28a and the first scan driving circuit 23 and with the second scan driving circuit 24. Any ways of electrical connection enabling the conductive wire 49 to electrically connect the first scan driving circuit 23 with the second scan driving circuit 24 are compliant with the spirit of the present invention.

### Fourth Embodiment

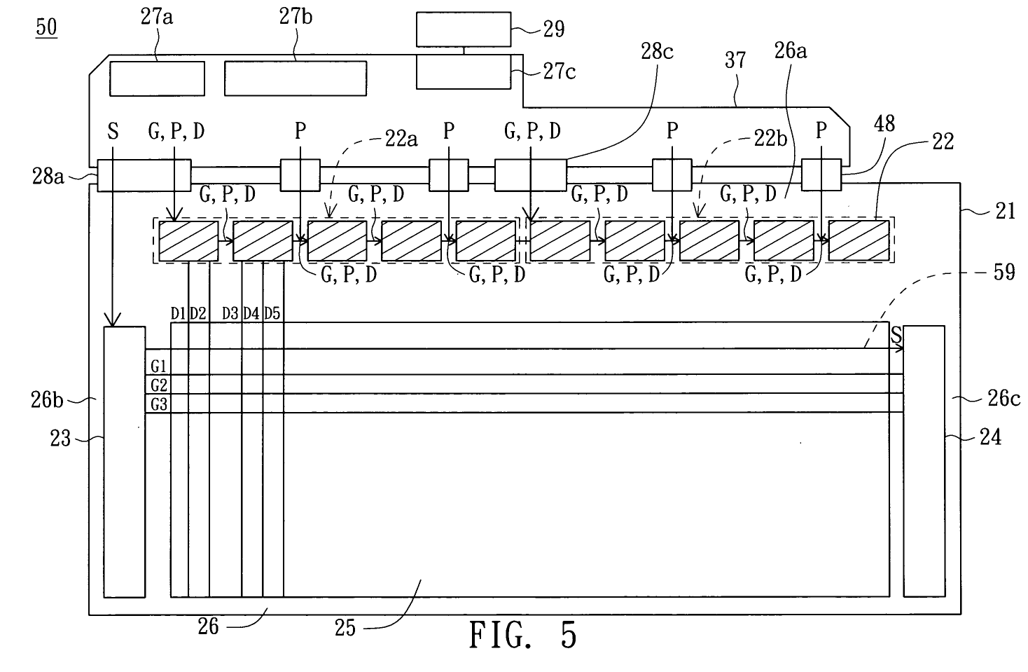

Referring to FIG. 5, a display panel according to a fourth embodiment of the present invention is shown. The display panel 50 of the present embodiment of the invention differs with the display panel 40 of the third embodiment in the position of the conductive wire 59. As for other similar elements, the same numeric designations are used and are not repeated here. Related description is illustrated in FIG. 2 and, is not repeated here.

As indicated in FIG. 5, the conductive wire 59 is disposed in the display region 25, and is electrically connected with the first scan driving circuit 23 and the second scan driving circuit 24. When the first flexible circuit board 28a transmits a scan driving circuit signal S to the first scan driving circuit 23, via the conductive wire 59 which is electrically connected with the first scan driving circuit 23 and the second scan driving circuit 24, the scan driving circuit signal S is transmitted to the second scan driving circuit 24 at the same time. The conductive wire 59 can be at least one dummy scan line (also referred as G0) of the scan lines. That is, the present embodiment of the invention is exemplified by a conductive wire 59 near to the data driving circuits 22 but is not limited thereto. The conductive wire 59 can be the last line of the scan lines, and the number of conductive wire 59 can be singular or plural. For example, with respect to the foremost conductive wire 59, at least one conductive wire 59 is disposed at the rearmost side to assure signal transmission quality. It is noted that the circuit board of the present embodiment of the invention does not have to be indented deeper into the first area 26a of the substrate. That is, the right side of the circuit board of the present embodiment of the invention can be aligned with the right side of the substrate. Alternatively, the width of the circuit board 37 can be substantially smaller than the sum of the width of display area 25 in the horizontal direction, the width of the second area 26b in the horizontal direction and the width of the third area 26c in the horizontal direction. Besides, the conductive wire 59 is not used as a scan line, that is, the voltage level of the conductive wire 59 does not change along with the scanning of the scan line. Normally, a voltage gate low (Vgl) is applied for maintaining the electrode stability of polarity of the pixels in the foremost row or rearmost row of the display region 25, such that the quality of the display panel is assured.

With the design of disposing one or several scan driving circuits to the two sides of the display region and incorporating serially connected data driving circuits, the display panel disclosed in the above embodiments of the invention reduces the size and layers of circuit boards as well as the size and required quantity of flexible circuit boards, hence reducing the manufacturing cost

While the present invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display panel, comprising:
a substrate having a display region and at least one non-display region adjacent to the display region, wherein the non-display region has at least one first area, at least one second area and at least one third area, and the first area connects the second area with the third area;
a plurality of data driving circuits disposed on the first area, wherein the data driving circuits are electrically connected in serial;
at least one first scan driving circuit disposed on the second area; and
at least one second scan driving circuit disposed on the third area.

2. The display panel according to claim 1, further comprising:
at least one circuit board;
at least one first flexible circuit board disposed between the substrate and the circuit board and electrically connected with the circuit board, the first scan driving circuit and a portion of the data driving circuits;
at least one second flexible circuit board disposed between the substrate and the circuit board and electrically connected with the circuit board and the second scan driving circuit; and
a plurality of third flexible circuit boards disposed between the substrate and the circuit board and electrically connected with the circuit board and the data driving circuits.

3. The display panel according to claim 2, wherein the data driving circuits are divided into at least one first group and at least one second group, the first flexible circuit board is electrically connected with the circuit board, the first scan driving circuit and one data driving circuit of the first group, the second flexible circuit board is electrically connected with the circuit board, the second scan driving circuit and one data driving circuit of the second group, and the third flexible circuit boards are electrically connected with the second group and the first group, respectively.

4. The display panel according to claim 3, wherein the first flexible circuit board transmits a signal to the one data driving circuit of the first group and the signal is substantially equal to a signal transmitted to the one data driving circuit of the second group by the third flexible circuit board.

5. The display panel according to claim 3, wherein a portion of the third flexible circuit boards transmits signals to the first group and the signals are substantially equal to signals transmitted to the second group by the other portion of the third flexible circuit boards.

6. The display panel according to claim 3, wherein the second flexible circuit board transmits a signal to the second scan driving circuit and the signal is substantially equal to a signal transmitted to the first scan driving circuit by the first flexible circuit board.

7. The display panel according to claim 2, wherein the circuit board comprises at least one connected port adapted to electrically connect with a system.

8. The display panel according to claim 2, wherein the second flexible circuit board is electrically connected with a portion of the data driving circuits.

9. The display panel according to claim 1, further comprising:
at least one circuit board;
at least one first flexible circuit board disposed between the substrate and the circuit board and electrically connected with the circuit board, the first scan driving circuit and a portion of the data driving circuits;
at least one conductive wire disposed on the first area and electrically connected with the first scan driving circuit and the second scan driving circuit; and
a plurality of second flexible circuit boards disposed between the substrate and the circuit board and electrically connected with the circuit board and the data driving circuits.

10. The display panel according to claim 9, wherein the data driving circuits are divided into at least one first group and at least one second group, the first flexible circuit board is electrically connected with the circuit board, the first scan driving circuit and one data driving circuit of the first group, and the second flexible circuit boards are electrically connected with the second group and the first group, respectively.

11. The display panel according to claim 10, wherein the first flexible circuit board transmits a signal to the one data driving circuit of the first group and the signal is substantially equal to a signal transmitted to one data driving circuit of the second group by one of the second flexible circuit board.

12. The display panel according to claim 10, wherein a portion of the second flexible circuit boards transmits signals to the first group and the signals are substantially equal to signals transmitted to the second group by the other portion of the second flexible circuit boards.

13. The display panel according to claim 9, wherein the circuit board comprises at least one connected port adapted to electrically connect with a system.

14. The display panel according to claim 1, further comprising:
a circuit board;
at least one first flexible circuit board disposed between the substrate and the circuit board, and is electrically connected with the circuit board, the first scan driving circuit and a portion of the data driving circuits;
at least one conductive wire disposed in the display region, and electrically connected with the first scan driving circuit and the second scan driving circuit; and
a plurality of the second flexible circuit boards disposed between the substrate and the circuit board, and electrically connected with the circuit board and the data driving circuits.

15. The display panel according to claim 14, wherein the data driving circuits are divided into at least one first group and at least one second group, the first flexible circuit board is electrically connected with the circuit board, the first scan driving circuit and one data driving circuit of the first group, and the second flexible circuit boards are electrically connected with the second group and the first group, respectively.

16. The display panel according to claim 15, wherein the first flexible circuit board transmits a signal to one data driving circuit of the first group and the signal is substantially equal to a signal transmitted to one data driving circuit of the second group by the second flexible circuit board.

17. The display panel according to claim 15, wherein a portion of the second flexible circuit boards transmits signals to the first group and the signals are substantially equal to signals transmitted to the second group by the other portion of the second flexible circuit boards.

18. The display panel according to claim 14, wherein the circuit board comprises at least one connected port adapted to electrically connect with a system.

19. The display panel according to claim 1, wherein at least one of the first scan driving circuit and the second scan driving circuit comprises a shift register circuit.

20. The display panel according to claim 1, wherein the display region comprises:
a plurality of data lines correspondingly and electrically connected with the data driving circuits; and
a plurality of scan lines substantially interlaced with the data lines and electrically connected with at least one of the first scan driving circuit and the second scan driving circuit.

21. The display panel according to claim 14, wherein the display region comprises:
a plurality of data lines correspondingly and electrically connected with the data driving circuits; and
a plurality of scan lines substantially interlaced with the data lines and electrically connected with at least one of the first scan driving circuit and the second scan driving circuit.

22. The display panel according to claim 14, wherein the conductive wire is a dummy scan line of the scan lines.

23. A photoelectronic display device incorporating a display panel according to claim 1.
